(19) United States
(12) Patent Application Publication
(10) Pub. No.: US 2023/0344780 A1
(43) Pub. Date: Oct. 26, 2023

(54) PACKET RECEIVING METHOD AND INFORMATION PROCESSING APPARATUS

(71) Applicant: Fujitsu Limited, Kawasaki-shi (JP)

(72) Inventor: Jun KATO, Kawasaki (JP)

(73) Assignee: Fujitsu Limited, Kawasaki-shi (JP)

(21) Appl. No.: 18/152,459

(22) Filed: Jan. 10, 2023

(30) Foreign Application Priority Data
Apr. 26, 2022 (JP) 2022-072414

(51) Int. Cl. H04L 47/56; H04L 43/103

(52) U.S. Cl. CPC H04L 47/564; H04L 43/103

(57) ABSTRACT

When a user thread with a deadline waits for a packet, a computer determines a reference time that is associated with and comes before the deadline. If the packet is not received by a communication interface by the reference time, the computer transfers control to a kernel thread and uses the kernel thread to perform polling to repeatedly check reception status of the communication interface. When the packet is received by the communication interface during polling, the computer uses the kernel thread to read out the received packet and pass the read packet to the user thread.

### CROSS-REFERENCE TO RELATED APPLICATION

This application is based upon and claims the benefit of priority of the prior Japanese Patent Application No. 2022-072414, filed on Apr. 26, 2022, the entire contents of which are incorporated herein by reference.

### FIELD

The embodiments discussed herein relate to a packet receiving method and information processing apparatus.

### BACKGROUND

An information processing apparatus may start a user thread to carry out data processing for a different information processing apparatus upon request therefrom. The user thread may wait for packets received from the other information processing apparatus before starting the data processing. The following packet processing is typically executed from when a communication interface, such as a network interface card (NIC), receives packets to when the user thread receives the packets.

When the communication interface receives a packet, an operating system (OS) starts a kernel thread by interrupt processing. The kernel thread reads out the received packet and analyses the packet header to determine a destination user thread of the packet. The kernel thread passes the packet to the user thread through processing, such as writing the packet to a memory area corresponding to the user thread. The OS releases the user thread waiting for packet reception from the waiting state.

A packet transfer apparatus has been proposed that reduces delay jitters caused by packets accumulated in a buffer. The proposed packet transfer apparatus estimates the delay time from packet reception to transfer, and determines a discard rule for regularly discarding some packets from the buffer based on the estimated delay time and a target delay time.

See, for example, International Publication Pamphlet No. WO2019/244828.

### SUMMARY

According to an aspect, there is provided a non-transitory computer-readable recording medium storing therein a computer program that causes a computer to execute a process including determining, responsive to a user thread with a deadline waiting for a packet, a reference time that is associated with the deadline and comes before the deadline; transferring, responsive to the packet being not received by a communication interface by the reference time, control to a kernel thread and causing the kernel thread to perform polling to repeatedly check reception status of the communication interface; and causing, responsive to the packet being received by the communication interface during the polling, the kernel thread to read out the packet that has been received and pass the packet that has been read out to the user thread.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an information processor according to a first embodiment;

FIG. 2 illustrates an example of an information processing system according to a second embodiment;

FIG. 3 is a block diagram illustrating an example of a hardware configuration of an endpoint device;

FIG. 4 is a block diagram illustrating an example of a hardware configuration of an edge server;

FIG. 5 illustrates an example of threads executed on the edge server;

FIG. 6 illustrates an example of communication between the endpoint device and the edge server;

FIG. 7 is an example of execution start times of threads;

FIG. 8 is a block diagram illustrating an example of functions of the edge server;

FIG. 9 illustrates an example of a reception history table;

FIG. 10 illustrates an example of a thread management table;

FIG. 11 is a flowchart illustrating an example of a procedure for reception waiting setup;

FIG. 12 is a flowchart illustrating an example of a procedure for interrupt reception; and

FIG. 13 is a flowchart illustrating an example of a procedure for polling reception.

### DESCRIPTION OF EMBODIMENTS

A user thread in a real-time application may be given a data processing deadline. On the other hand, if a network for transmitting packets exhibits an increased communication delay, time delays may occur for the user thread to receive packets and start data processing. This may in turn shorten the grace period for the data processing before the deadline.

In this regard, if the information processing apparatus is able to reduce the packet processing time spanning from packet reception by the communication interface up to packet reception by the user thread, it is possible to reduce the delay in starting the processing of the user thread. In typical packet processing, however, after the packet reception by the communication interface, a kernel thread, which is different from the user thread with a deadline, is started by interrupt processing. Therefore, the packet processing using the kernel thread may fail to be executed promptly.

Several embodiments will now be described below with reference to the accompanying drawings.

### (A) First Embodiment

A first embodiment is described hereinafter.

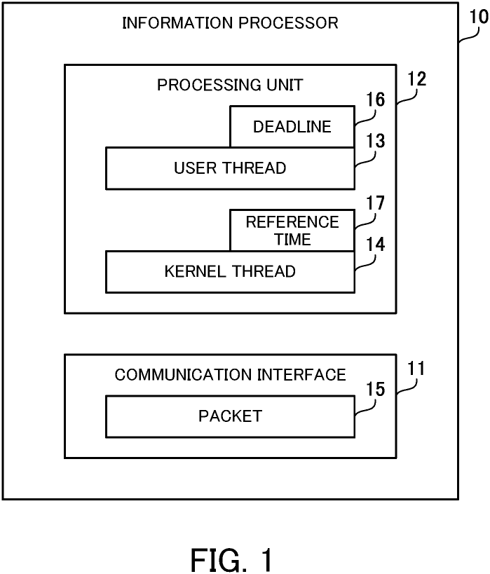

FIG. 1 illustrates an information processor according to the first embodiment.

An information processor 10 of the first embodiment executes, as application software, a real-time application for completing data processing within a specified period of time from a certain start time. The information processor 10 receives packets from a different information processor via a network and performs data processing using the received packets. The information processor 10 may transmit results of the data processing to the other information processor. For example, the information processor 10 receives image data from the other information processor and returns results of image recognition performed on the image data. The information processor 10 may be referred to, for example, as a computer or packet receiving device.

The information processor 10 has a communication interface 11 and a processing unit 12. The communication interface 11 is a hardware interface for receiving packets. The communication interface 11 is connected to a network. The network may include a wired network, and may include a wireless network. The communication interface 11 is equivalent, for example, to a NIC or communication port. As described later, the communication interface 11 receives packets for which a user thread 13 is waiting. Note however that the communication interface 11 may also receive packets not addressed to the user thread 13, such as packets addressed to other user threads.

The processing unit 12 is a processor. The processing unit 12 may include a central processing unit (CPU), graphics processing unit (GPU), digital signal processor (DSP), application specific integrated circuit (ASIC), or field programmable gate array (FPGA). The processor executes programs stored in memory. The programs may include a packet reception program. The term “multiprocessor”, or simply “processor”, may be used to refer to a set of multiple processors. The information processor 10 may have volatile semiconductor memory, such as random access memory (RAM), or a non-volatile storage device, such as hard disk drive (HDD) or flash memory.

The processing unit 12 executes the user thread 13 for a real-time application. A deadline 16 is assigned to the user thread 13. The deadline 16 is the assigned time by which the user thread 13 is desired to complete its data processing. The deadline 16 may be calculated by adding a defined period of time to a given start time. The start time may be notified in advance by the other information processor that transmits a packet 15, or may be agreed in advance between the information processor 10 and the other information processor. The processing unit 12 may determine execution schedules for multiple threads based on their deadlines. For example, the processing unit 12 gives higher priorities to threads with earlier deadlines.

The user thread 13 starts data processing after receiving the packet 15. Therefore, the user thread 13 is sometimes in a waiting state, waiting for arrival of the packet 15. For example, the user thread 13 makes a system call indicating a packet reception request to an OS, and moves into a waiting state to which CPU time is not allocated. The packet reception request may specify a memory area in user space for the user thread 13 to receive the packet 15, or may specify the data length of data to be received at one time.

In the case where the user thread 13 waits for the packet 15, the processing unit 12 determines a reference time 17. The processing unit 12 may determine the reference time 17 when the user thread 13 enters the waiting state. The reference time 17 is associated with and comes before the deadline 16. The reference time 17 may be obtained by adding a defined period of time to a start time corresponding to the deadline 16 or by subtracting a defined period of time from the deadline 16. The defined period of time added to the start time may be the maximum delay time of the network carrying the packet 15. The maximum delay time may be a theoretical maximum delay time stipulated in the specifications of the network.

In addition, the processing unit 12 may adjust the reference time 17 based on the start time for starting a kernel thread 14 to be described later. For example, the processing unit 12 moves the reference time 17 forward from the above time by the start time of the kernel thread 14. Further, the processing unit 12 may adjust the reference time 17 by referring to reception history data indicating reception times and destinations of packets received by the communication interface 11 in the past. For example, the processing unit 12 calculates expected reception time based on a mix rate of packets not addressed to the user thread 13, an average packet reception interval, and the number of remaining packets for the user thread 13, and moves the reference time 17 forward by the expected reception time.

When the packet 15 is not received by the communication interface 11 by the reference time 17, the processing unit 12 transfers control to the kernel thread 14. If the kernel thread 14 has not been started, the processing unit 12 may start the kernel thread 14. The processing unit 12 may use a hardware timer and transfer control to the kernel thread 14 when the current time reaches the reference time 17. The kernel thread 14 is a thread executed in kernel space of the OS. The kernel thread 14 may be given the deadline 16 of the user thread 13, or may be executed with priority according to the deadline 16. For example, the kernel thread 14 is executed with the same priority as the user thread 13 in terms of OS scheduling.

The processing unit 12 uses the kernel thread 14 to perform polling to repeatedly check the packet reception status of the communication interface 11. For example, the processing unit 12 determines, by polling, whether at least one packet has been received. The polling may be performed at intervals shorter than the average packet reception interval of the communication interface 11.

In the case where a receiving buffer resides in the communication interface 11, the processing unit 12 may repeatedly access the communication interface 11. On the other hand, if the receiving buffer is provided in memory external to the communication interface 11, the processing unit 12 may repeatedly access a memory area where the receiving buffer is located. The external memory may be RAM, and packets may be written from the communication interface 11 to the external memory by direct memory access (DMA). The processing unit 12 may repeatedly check a control flag that indicates the presence or absence of a packet.

The processing unit 12 detects that a packet has been received by the communication interface 11 during polling. When the packet 15 has been received, the processing unit 12 uses the kernel thread 14 to read out the packet 15 and pass the packet 15 to the user thread 13.

For example, the kernel thread 14 reads out the packet 15 from the receiving buffer internal or external to the communication interface 11, analyzes the header of the packet 15, and determines that the packet 15 is addressed to the user thread 13. The kernel thread 14 writes the packet 15 to a memory area in user space, corresponding to the user thread 13. The memory area may be designated by the user thread 13, and is sometimes called a socket. When reception of all packets for which the user thread 13 is waiting is completed, the OS releases the user thread 13 from the waiting state and makes the user thread 13 ready to be executed.

Note that the information processor 10 may virtualize the communication interface 11. For example, the information processor 10 sets a virtual communication port for each of multiple user threads, and executes kernel threads individually corresponding to each of the user threads. In the case where the communication interface 11 is virtualized, a receiving buffer corresponding to the user thread 13 may store packets addressed to the user thread 13 and may store no packets that are addressed to other user threads. Even in that case, however, packets other than those addressed to the user thread 13, such as broadcast packets, may be mixed in the receiving buffer.

As described above, when the user thread 13 waits for the packet 15, the information processor 10 of the first embodiment determines the reference time 17 that is associated with and comes before the deadline 16. When the packet 15 is not received by the reference time 17, the information processor 10 transfers control to the kernel thread 14 and uses the kernel thread 14 to perform polling to repeatedly check the reception status of the communication interface 11. If the packet 15 is received during polling, the information processor 10 uses the kernel thread 14 to read out the packet 15 and pass the packet 15 to the user thread 13.

This reduces the overhead after the packet 15 is received compared to the case where the kernel thread 14 is started by an interrupt after the packet 15 is received by the communication interface 11. In addition, the kernel thread 14 having performed polling goes on processing the packet 15 without thread switching. Therefore, after the reference time 17 has passed, the packet processing time spanning from when the communication interface 11 receives the packet 15 to when the user thread 13 receives the packet 15 is shortened. This reduces delay in starting data processing of the user thread 13 due to network communication delay, thus increasing the grace period for the data processing before the deadline 16. In turn, the information processor 10 is able to advance the deadline 16 to be promised to the other information processor.

Note that the information processor 10 may execute the kernel thread 14 with priority according to the deadline 16. As a result, the kernel thread 14 is preferentially executed over threads with late or no deadlines, which shortens the packet processing time after the kernel thread 14 is started.

The information processor 10 may determine the reference time 17 using the start time corresponding to the deadline 16 and the maximum delay time of the network. In addition, the information processor 10 may calculate, based on reception history data, the average reception interval and the mix rate of packets not addressed to the user thread 13, which may be then used to determine the reference time 17. This shortens the polling time spanning from when the kernel thread 14 starts polling to when the packet 15 arrives, thus reducing the load on the information processor 10.

Further, when some packets are received before the reference time 17, the information processor 10 may update the reference time 17 based on the number of remaining packets to be received. As a result, even if the communication delay increases from a packet in the middle onward amongst multiple packets, polling of the kernel thread 14 is started at an appropriate time.

### (B) Second Embodiment

A second embodiment is described hereinafter.

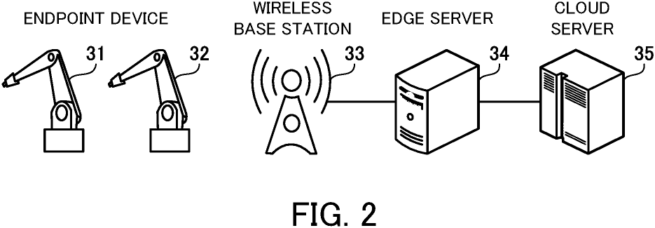

FIG. 2 illustrates an example of an information processing system according to the second embodiment.

The information processing system of the second embodiment includes multiple endpoint devices, such as endpoint devices 31 and 32, a wireless base station 33, an edge server 34, and a cloud server 35. The edge server 34 corresponds to the information processor 10 of the first embodiment.

The endpoint devices 31 and 32 are client devices for the edge server 34 on which real-time applications run. The endpoint devices 31 and 32 call on the real-time applications to produce analysis results of data within a specified period of time after the data is generated. In the second embodiment, the endpoint devices 31 and 32 have an imaging unit for generating image data, and the real-time applications are image recognition applications. Examples of the endpoint devices 31 and 32 include surveillance cameras and drones.

The endpoint devices 31 and 32 communicate wirelessly with the wireless base station 33. The endpoint devices 31 and 32 periodically transmit image data to the edge server 34 via the wireless base station 33 and receive image recognition results from the edge server 34 via the wireless base station 33. The transmission cycle of image data is, for example, about several tens of milliseconds to several hundred milliseconds. The image recognition results include, for example, information on an image area and information on the class of an object captured in the image area.

The wireless base station 33 is a communication device for communicating wirelessly with the endpoint devices 31 and 32 and communicating with the edge server 34 using a wired connection. The wireless base station 33 receives packets of image data from the endpoint devices 31 and 32 and transfers them to the edge server 34. In addition, the wireless base station 33 receives packets of image recognition results from the edge server 34 and transfers them to the endpoint devices 31 and 32. For example, image data of one image is about several tens of kilobytes, which corresponds to several packets to several tens of packets.

The edge server 34 is a server computer for running real-time applications. The edge server 34 is located closer to the wireless base station 33 than the cloud server 35 is. The edge server 34 establishes transmission control protocol (TCP) connections with the endpoint devices 31 and 32, and starts one user thread for each of the endpoint devices 31 and 32. The user thread periodically receives image data, implements image recognition on the received image data, and returns the image recognition results.

The edge server 34 has larger hardware resources than the endpoint devices 31 and 32, and is able to implement image recognition faster than the endpoint devices 31 and 32. For example, the edge server 34 uses a GPU to implement image recognition at high speed. The edge server 34 is notified by the endpoint devices 31 and 32 of the transmission time of initial image data and a transmission cycle of subsequent image data. The edge server 34 is able to calculate the transmission time of image data for each cycle based on the transmission time of the first cycle and the transmission cycle. The user thread is supposed to complete image recognition within a specified period of time from the transmission time of each cycle.

The cloud server 35 is a server computer installed at a data center. The cloud server 35 is located further from the wireless base station 33 than the edge server 34 is. The cloud server 35 is also provided with sufficient hardware resources for image recognition. However, because the communication delay between the wireless base station 33 and the cloud server 35 may be large, the edge server 34 implements image recognition instead of the cloud server 35.

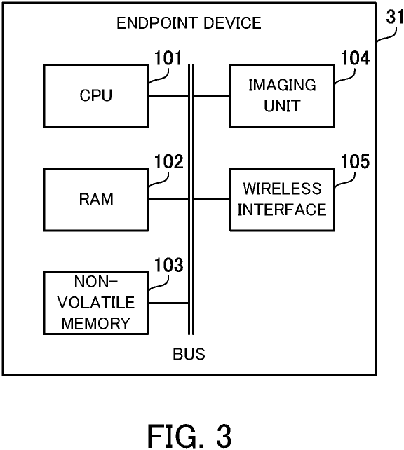

FIG. 3 is a block diagram illustrating an example of a hardware configuration of an endpoint device.

The endpoint device 31 includes a CPU 101, a RAM 102, a non-volatile memory 103, an imaging unit 104, and a wireless interface 105, which are individually connected to a bus. The endpoint device 32 also has the same hardware configuration as the endpoint device 31.

The CPU 101 is a processor configured to execute program instructions. The CPU 101 reads out programs and data stored in the non-volatile memory 103, loads them into the RAM 102, and executes the loaded programs. The endpoint device 31 may include two or more processors.

The RAM 102 is volatile semiconductor memory for temporarily storing therein programs to be executed by the CPU 101 and data to be used by the CPU 101 for its computation. Note that the endpoint device 31 may be provided with a different type of volatile memory other than RAM.

The non-volatile memory 103 is a non-volatile storage device to store therein software programs, such as an OS, middleware, and application software, and various types of data. The non-volatile memory 103 may be read only memory (ROM) or a rewritable memory device, such as a flash memory. The endpoint device 31 may have a different type of non-volatile storage, such as HDD.

The imaging unit 104 is an image sensor for generating image data. For example, the imaging unit 104 is a charge coupled device (CCD) image sensor. The imaging unit 104 generates image data in response to a request from the CPU 101 and stores the image data in the RAM 102.

The wireless interface 105 is a communication interface for establishing a wireless link with the wireless base station 33 and transmitting and receiving data over the wireless link. The wireless interface 105 reads out packets of image data from the RAM 102 and then transmits them to the wireless base station 33, and receives packets of image recognition results from the wireless base station 33 and stores them in the RAM 102. Note that the CPU 101 may exercise control over the behavior of the endpoint device 31 according to the image recognition results.

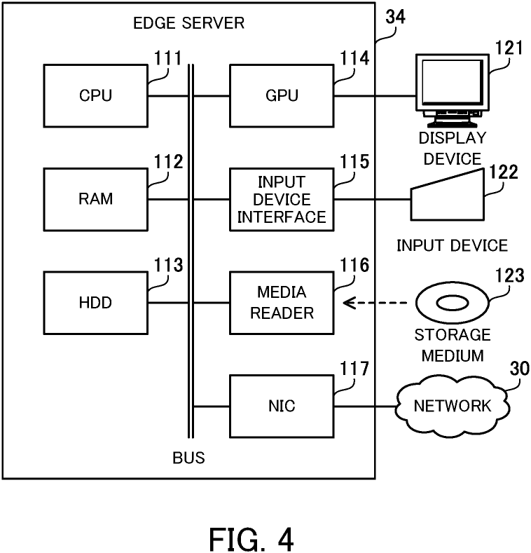

FIG. 4 is a block diagram illustrating an example of a hardware configuration of an edge server.

The edge server 34 includes a CPU 111, a RAM 112, an HDD 113, a GPU 114, an input device interface 115, a media reader 116, and a NIC 117, which are individually connected to a bus. The cloud server 35 may have the same hardware configuration as the edge server 34. The NIC 117 corresponds to the communication interface 11 of the first embodiment. The CPU 111 corresponds to the processing unit 12 of the first embodiment.

The CPU 111 is a processor configured to execute program instructions. The CPU 111 reads out programs and data stored in the HDD 113, loads them into the RAM 112, and executes the loaded programs. Note that the edge server 34 may include two or more processors.

The RAM 112 is volatile semiconductor memory for temporarily storing therein programs to be executed by the CPU 111 and data to be used by the CPU 111 for its computation. The edge server 34 may be provided with a different type of volatile memory other than RAM.

The HDD 113 is a non-volatile storage device to store therein software programs, such as an OS, middleware, and application software, and various types of data. The programs include a packet reception program. The edge server 34 may be provided with a different type of non-volatile storage device, such as flash memory or a solid state drive (SSD).

The GPU 114 performs image processing in cooperation with the CPU 111, and displays video images on a screen of a display device 121 coupled to the edge server 34. The display device 121 may be a cathode ray tube (CRT) display, a liquid crystal display (LCD), an organic electroluminescence (OEL) display, or a projector. In addition, the GPU 114 may be used as a general-purpose computing on graphics processing unit (GPGPU). The GPU 114 may execute a program according to an instruction from the CPU 111. The edge server 34 may have volatile semiconductor memory as GPU memory other than the RAM 112.

The input device interface 115 receives an input signal from an input device 122 connected to the edge server 34. Various types of input devices may be used as the input device 122, for example, a mouse, a touch panel, or a keyboard. Multiple types of input devices may be connected to the edge server 34.

The media reader 116 is a device for reading programs and data recorded on a storage medium 123. The storage medium 123 may be, for example, a magnetic disk, an optical disk, or semiconductor memory. Examples of the magnetic disk include a flexible disk (FD) and HDD. Examples of the optical disk include a compact disc (CD) and digital versatile disc (DVD). The media reader 116 copies the programs and data read out from the storage medium 123 to a different storage medium, such as the RAM 112 or the HDD 113. The read programs may be executed by the CPU 111.

The storage medium 123 may be a portable storage medium and used to distribute the programs and data. In addition, the storage medium 123 and the HDD 113 may be referred to as computer-readable storage media.

The NIC 117 is a wired communication interface for communicating with the wireless base station 33 via a network 30. The NIC 117 includes one or more communication ports. The NIC 117 is connected to wired communication devices, such as switches and routers, by cables. The NIC 117 receives packets from the wireless base station 33. The NIC 117 stores the received packets in a receiving buffer located inside the NIC 117 or residing on the RAM 112. Data is transferred between the RAM 112 and the NIC 117 by DMA. The receiving buffer may have a control flag that indicates whether there is a packet in the receiving buffer.

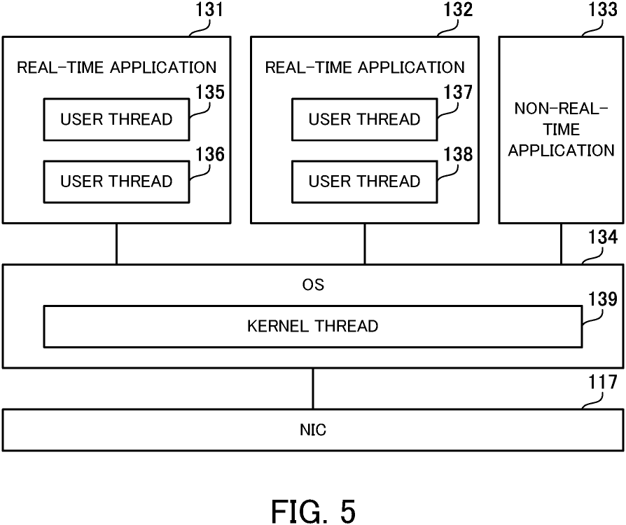

FIG. 5 illustrates an example of threads executed on an edge server.

The edge server 34 includes real-time applications 131 and 132, a non-real-time application 133, and an operating system (OS) 134.

The real-time application 131 is application software for performing image recognition on received image data. The GPU 114 may be used for the image recognition. The real-time application 131 starts a user thread 135 for the endpoint device 31 in response to a request from the endpoint device 31. The real-time application 131 also starts a user thread 136 for the endpoint device 32 in response to a request from the endpoint device 32.

The user thread 135 is notified by the endpoint device 31 of the initial transmission time and the transmission cycle before receiving image data of the first cycle. Based on the information, the user thread 135 identifies the transmission time of image data of the next cycle, and calculates the next deadline by adding a defined period of time to the next transmission time. The user thread 135 completes image recognition for the next image data by this deadline. Similarly, the user thread 136 is notified by the endpoint device 32 of the initial transmission time and the transmission cycle. The user thread 136 calculates the next deadline by adding a defined period of time to the next transmission time and completes image recognition for the next image data by this deadline.

The real-time application 132 is application software that performs data processing different from that of the real-time application 131. The real-time application 132 starts user threads 137 and 138. The user threads 137 and 138 are assigned deadlines in the same manner as the user threads 135 and 136.

The non-real-time application 133 is application software for which real-time responses are not sought. The non-real-time application 133 starts one or more threads with no deadline given.

The OS 134 is control software for managing hardware resources of the edge server 34. The OS 134 starts a kernel thread 139 that performs packet processing. The kernel thread 139 transfers packets between the NIC 117 and the user threads 135, 136, 137, and 138.

The OS 134 also schedules the allocation of CPU time of the CPU 111 to the user threads 135, 136, 137, and 138 and the kernel thread 139. The OS 134 performs deadline scheduling to determine the priority of each thread according to its deadline. A thread with an earlier deadline has a higher priority, and a thread with no deadline has a lower priority than a thread with a deadline. Note that the user threads 135, 136, 137, and 138 are executed in user space while the kernel thread 139 is executed in kernel space.

Packets received by the NIC 117 are passed to the user threads 135, 136, 137, and 138, in principle, as follows. When a user thread waits for packets, the user thread makes a system call indicating a packet reception request to the OS 134. The packet reception request specifies a memory area in user space where the packets are to be written and the data length of the packets expected to be received. The user thread moves into a waiting state to which CPU time is not allocated.

Upon receiving a packet, the NIC 117 writes the received packet to a receiving buffer in memory located inside the NIC 117 or residing outside the NIC 117 (e.g., the RAM 112). The receiving buffer has a control flag that indicates whether there is a received packet therein. The NIC 117 notifies the CPU 111 by a hardware interrupt that a packet has been received.

The OS 134 running on the CPU 111 starts the kernel thread 139 by a software interrupt. The kernel thread 139 reads out a packet from the receiving buffer and performs a protocol process to analyze the header of the packet. The kernel thread 139 determines a destination user thread based on the header, and writes the packet to a memory area corresponding to the destination user thread. The destination user thread is determined, for example, by the destination Internet Protocol (IP) address and destination port number.

Note however that the kernel thread 139 started by interrupt processing does not have a deadline. Therefore, in terms of deadline scheduling, the kernel thread has a lower priority than the user threads 135 and 136, and thus packet processing of the kernel thread 139 does not always start immediately. When a user thread has received all the requested packets, the OS 134 releases the user thread from the waiting state. The user thread released from the waiting state enters an execution-ready state, and is allocated CPU time according to the deadline scheduling.

Note that the edge server 34 may virtualize the NIC 117. In that case, the edge server 34 arranges virtual communication port and receiving buffer for each user thread and starts a kernel thread for each user thread. However, even when the NIC 117 is virtualized, packets other than those addressed to each specific user thread, such as broadcast packets, may be mixed in the receiving buffer.

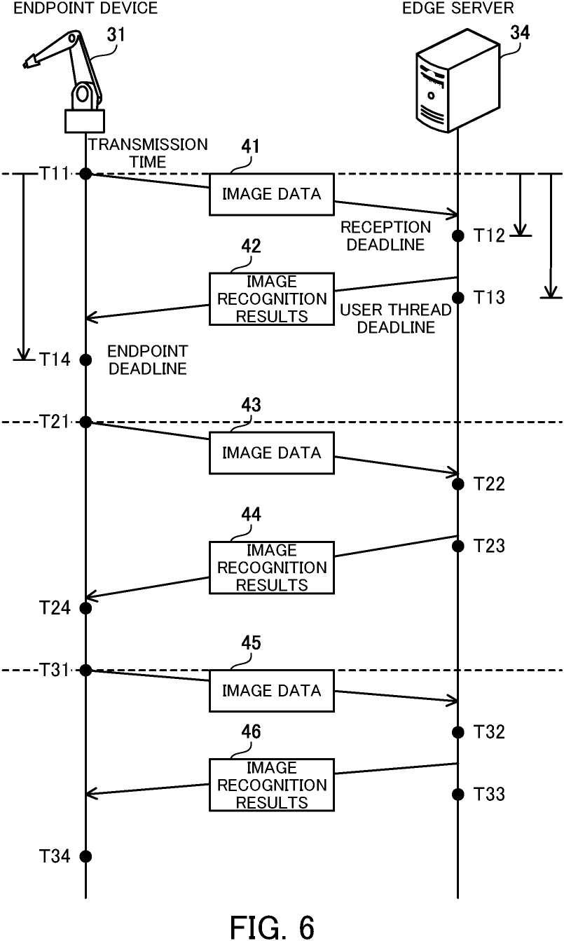

FIG. 6 illustrates an example of communication between an endpoint device and an edge server.

Here, communication between the endpoint device 31 and the edge server 34 is described as an example; however, similar communication takes place between the endpoint device 32 and the edge server 34.

The endpoint device 31 transmits packets of image data 41 at time T11. Time T11 is the transmission time, and it is the start time for the endpoint device 31 to start processing for the image data 41. By time T12, the edge server 34 receives the packets of the image data 41 via a wireless communication network. Time T12 is a reception deadline of a maximum delay in the packet transmission of the wireless communication network, and is obtained by adding a theoretical maximum delay time to time T11. In many cases, the edge server 34 finishes receiving the packets of the image data 41 before time T12. However, the actual reception time is uncertain since the delay time of the wireless communication network varies.

By time T13, the edge server 34 completes image recognition for the image data 41. Then, the edge server 34 transmits packets of image recognition results 42. Time T13 is a user thread deadline, and is obtained by adding a defined period of time to time T12. This defined period of time includes the maximum required time for packet processing by the kernel thread 139 and the maximum required time for image recognition by the user thread 135. Therefore, time T13 is obtained by adding, to the transmission time, the maximum delay time of the wireless communication network, the maximum required time for the packet processing, and the maximum required time for the image recognition. The maximum required time for the packet processing and that for the image recognition are estimated in advance by a business operator who runs the edge server 34.

By time T14, the endpoint device 31 receives the packets of the image recognition results 42. Time T14 is an endpoint deadline for the endpoint device 31 to complete the processing for the image data 41. Time T14 is time T13 plus a theoretical maximum delay time of the wireless communication network. Therefore, time T14 is obtained by adding, to the transmission time, the maximum round-trip delay time of the wireless communication network and the maximum required time for the packet processing and the image recognition at the edge server 34. The maximum waiting time from time T11 to time T14 is determined in advance by a contract between a user who uses the endpoint device 31 and the business operator who runs the edge server 34.

Similarly, the endpoint device 31 transmits packets of image data 43 at time T21. Time T21 is the next transmission time obtained by adding the time taken for one cycle to time T11. By time T22, the edge server 34 receives the packets of the image data 43. Time T22 is a reception deadline corresponding to time T21. The edge server 34 completes image recognition by time T23 and transmits packets of image recognition results 44. Time T23 is a user thread deadline corresponding to time T21. The endpoint device 31 receives the packets of the image recognition results 44 by time T24. Time T24 is an endpoint deadline corresponding to time T21.

Further, the endpoint device 31 transmits packets of image data 45 at time T31. Time T31 is the next transmission time obtained by adding the time taken for one cycle to time T21. The edge server 34 receives the packets of the image data 45 by time T32. Time T32 is a reception deadline corresponding to time T31. The edge server 34 completes image recognition by time T33 and transmits packets of image recognition results 46. Time T33 is a user thread deadline corresponding to time T31. The endpoint device 31 receives the packets of the image recognition results 46 by time T34. Time T34 is an endpoint deadline corresponding to time T31.

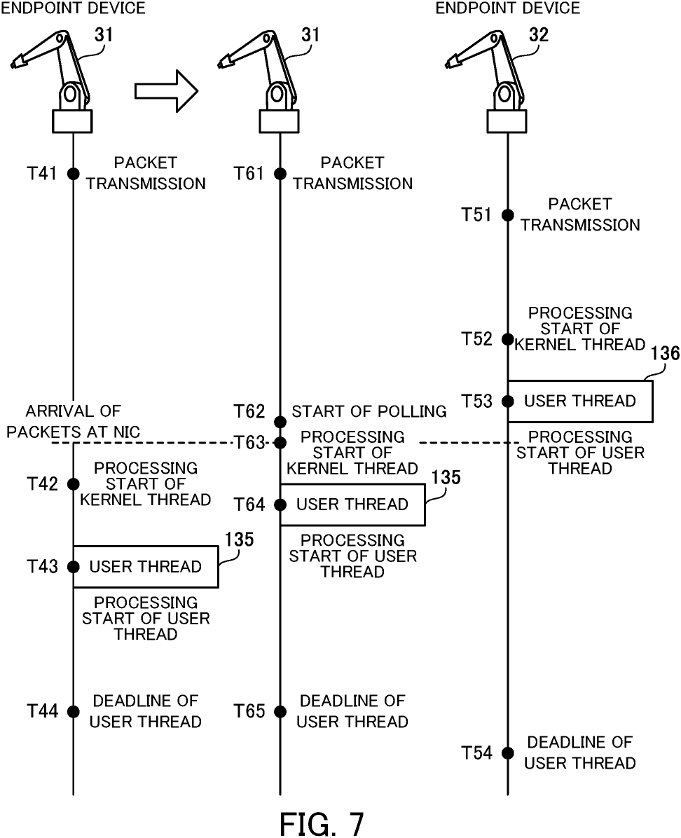

FIG. 7 is an example of execution start times of threads.

The example of FIG. 7 depicts deadline management from the perspective of the edge server 34 when the user threads 135 and 136 coexist.

The endpoint device 32 transmits packets of image data at time T51. When the packets arrive at the NIC 117, the edge server 34 starts the kernel thread 139. The kernel thread 139 starts processing at time T52. After the processing of the kernel thread 139 finishes, the user thread 136 starts processing at time T53. A user tread deadline corresponding to time T51 is time T54. After time T53, the user thread 136 is executed with priority according to time T54. Note that the processing below time T51 in FIG. 7 is performed by the edge server 34.

On the other hand, the endpoint device 31 transmits packets of image data at time T41. When the packets arrive at the NIC 117, the edge server 34 starts the kernel thread 139. The kernel thread 139 starts processing at time T42. After the processing of the kernel thread 139 finishes, the user thread 135 starts processing at time T43. A user thread deadline corresponding to time T41 is time T44. After time T43, the user thread 135 is executed with priority according to time T44. Note that the processing below time T41 in FIG. 7 is performed by the edge server 34.

Time T41 is earlier than time T51, and time T44 is earlier than time T54. However, the transmission delay of the wireless communication network for the packets of the endpoint device 31 is greater than that of the endpoint device 32. For this reason, the packets of the endpoint device 31 arrive at the NIC 117 later than those of the endpoint device 32.

Even if the packets of the endpoint device 31 arrive at the NIC 117, processing of the kernel thread 139 does not start immediately because of the overhead of starting the kernel thread 139 by interrupt processing. In addition, at time T42, the user thread 136 with a deadline is being executed. Since no deadline is given to the kernel thread 139, the priority of the kernel thread 139 is lower than that of the user thread 136, and the processing of the kernel thread 139 may be delayed. As a result, time T43 is delayed, which shortens the grace period spanning from time T43 to time T44.

Even in the case where the packet communication delay of the endpoint device 31 is large, if the edge server 34 is able to shorten the packet processing time from the arrival of the packets at the NIC 117 to the start of processing by the user thread 135, the impact of the communication delay is alleviated. This increases the grace period for image recognition and reduces the burden on thread scheduling. In addition, the business operator who runs the edge server 34 is able to guarantee shorter maximum waiting time to the users, which increases the value of the real-time applications. In view of the above, the edge server 34 of the second embodiment shortens the packet processing time in the following manner.

The endpoint device 31 transmits packets of image data at time T61. The edge server 34 sets polling start time when the user thread 135 moves into a waiting state. Time T62 is the polling start time. The edge server 34 starts the kernel thread 139 when there is one or more unreceived packets at time T62. At time T62, control is passed to the kernel thread 139, which then starts polling.

The kernel thread 139 started here performs polling to repeatedly check the receiving buffer of the NIC 117. For example, the kernel thread 139 repeatedly checks a control flag which indicates whether there is a received packet. The polling is performed in a sufficiently short cycle, e.g., less than 1 microsecond. In addition, the kernel thread 139 takes over the deadline given to the user thread 135. Time T65 is the user thread deadline corresponding to time T61. Therefore, the edge server 34 executes the kernel thread 139 with priority corresponding to time T65.

At time T63, the kernel thread 139 detects the arrival of packets at the NIC 117. Then, the kernel thread 139 starts processing for the received packets without the overhead of thread switching by interrupt processing. Because the polling is performed at sufficiently short intervals, packet processing starts immediately after the packet arrival. After the processing of the kernel thread 139 finishes, the user thread 135 starts processing at time T64. Since having priority corresponding to time T65, the kernel thread 139 is executed with priority over the user thread 136, which has priority corresponding to time T54. As a result, the packet processing time spanning from time T63 to time T64 is shortened. Note that the processing below time T61 in FIG. 7 is performed by the edge server 34.

Note that the edge server 34 preferably does not set the polling start time too early because polling may increase the load on the edge server 34. In the second embodiment, the edge server 34 determines the polling start time on the assumption that packets requested by the user thread 135 are collectively received immediately before the reception deadline. This situation corresponds to a case where the maximum delay in the wireless communication network has occurred. A specific example of how to calculate the polling start time is described next.

The edge server 34 continuously records packet reception history of packets having arrived at the NIC 117. The packet reception history includes, for example, records for the latest several thousands of packets. Each record maps the reception time of a packet to a destination thread. The edge server 34 calculates the average reception interval and the mix rate from the packet reception history. The average reception interval is the average reception time difference between two neighboring packets and, for example, 10 microseconds. The mix rate is the ratio of packets not addressed to the user thread 135 to all packets. The mix rate obtained for a virtualized receiving buffer is, for example, 20%.

The edge server 34 identifies the number of waiting packets N of the user thread 135 when the user thread 135 moves into a waiting state. The edge server 34 calculates the expected number of reception packets N′ from the number of waiting packets N and the mix rate. The expected number of reception packets N′ is an estimate of the number of packets to be received until all the waiting packets of the user thread 135 arrive, including packets not addressed to the user thread 135. If the mix rate is 20%, N′ = N/(1 - 0.2) = 1.25N.

The edge server 34 calculates expected reception time T from the expected number of reception packets N′ and the average reception interval. The expected reception time T is an estimate of the communication time to receive N′ packets. If the average reception interval is 10 microseconds, then T = 10N′ = 12.5N. The edge server 34 calculates the polling start time from a current reception deadline D, thread start time α which is an overhead of starting the kernel thread 139, and the expected reception time T. The polling start time is, for example, D - (T + α). Note however that the polling start time may be set to a defined period of time earlier than D - (T + α).

Note that the edge server 34 may calculate the average reception interval and the mix rate from the latest packet reception history each time polling start time is determined. Alternatively, the edge server 34 may periodically calculate the average reception interval and the mix rate from the packet reception history and store the calculated values. In that case, the most recent average reception interval and mix rate are used to determine the polling start time.

Next described are functions and processing procedures of the edge server 34.

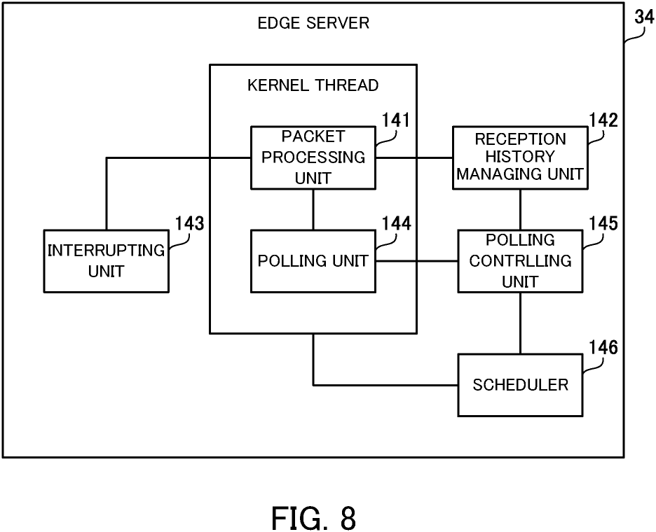

FIG. 8 is a block diagram illustrating an example of the functions of the edge server.

The edge server 34 includes a packet processing unit 141, a reception history managing unit 142, an interrupting unit 143, a polling unit 144, a polling controlling unit 145, and a scheduler 146. These processing units correspond to programs executed in kernel space.

The packet processing unit 141 is implemented in a kernel thread. The packet processing unit 141 reads out a packet from the receiving buffer provided inside or outside the NIC 117 and analyzes the header of the packet by performing protocol processing. The packet processing unit 141 determines a destination user thread based on the header, and writes the packet to a memory area of user space.

The reception history managing unit 142 manages the reception history of packets processed by the packet processing unit 141. The reception history managing unit 142 stores reception history data in a memory area of kernel space in the RAM 112. Each time the packet processing unit 141 processes one packet, the reception history managing unit 142 adds a record indicating the reception time and destination to the reception history data and deletes one old record therefrom.

The interrupting unit 143 is an interrupt handler implemented upon reception of a hardware interrupt from the NIC 117. When the NIC 117 receives a packet, the interrupting unit 143 starts a kernel thread by interrupt processing. In the kernel thread started here, the processing of the packet processing unit 141 is implemented. Note however that, if a kernel thread is already running for polling, the interrupt processing is not performed. No deadline is given to the kernel thread started by the interrupt processing.

The polling unit 144 is implemented in the same kernel thread as the packet processing unit 141. The polling unit 144 repeatedly checks a control flag of the receiving buffer provided inside or outside the NIC 117 at regular intervals. Upon detecting reception of a packet, the polling unit 144 calls the packet processing unit 141. The packet processing unit 141 starts packet processing in the same kernel thread as the polling unit 144. The polling unit 144 stops polling when all packets for the user thread have arrived.

The polling controlling unit 145 controls the start and end of polling performed by the polling unit 144. The polling controlling unit 145 determines the polling start time when a user thread with a deadline enters a waiting state and sets a timer so that a kernel thread is started at the polling start time to perform polling. The polling controlling unit 145 gives the kernel thread the same deadline as the user thread.

To determine the polling start time, the polling controlling unit 145 refers to the reception history data held by the reception history managing unit 142 and calculates parameter values, such as the average reception interval and the mix rate. If some of the packets for which the user thread is waiting are received before the polling start time, the polling controlling unit 145 updates the polling start time according to the number of remaining packets. If all the packets that the user thread is waiting for are received before the polling start time, the polling controlling unit 145 deletes the polling start time.

The scheduler 146 performs deadline scheduling to determine the priority of threads based on their deadlines. The scheduler 146 schedules the user threads 135 and 136 corresponding to the endpoint devices 31 and 32, respectively, and kernel threads having started by interrupt processing or polling start processing.

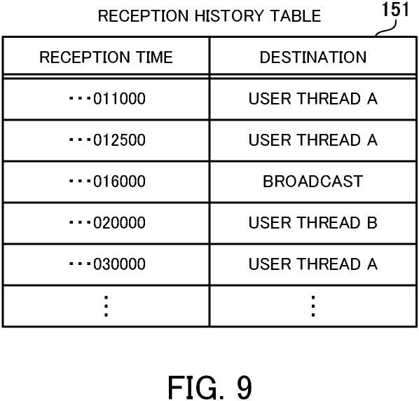

FIG. 9 illustrates an example of a reception history table.

A reception history table 151 is stored in the RAM 112. The reception history table 151 stores multiple records each including a reception time and a destination. The reception time is a time stamp capable of distinguishing microseconds or less. A value of a CPU counter that counts up for each clock of the CPU 111 may be used for each reception time. Each destination identifies a user thread. A thread ID or port number may be used as the destination.

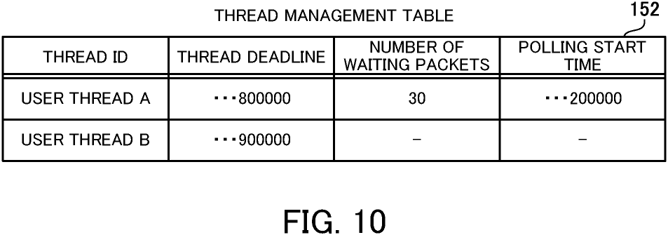

FIG. 10 illustrates an example of a thread management table.

A thread management table 152 is stored in the RAM 112. The thread management table 152 stores each record in which a thread ID, a thread deadline, the number of waiting packets, and a polling start time are mapped to each other. Each thread ID identifies a user thread. Each thread deadline is an image recognition deadline for the next image data. The initial thread deadline is calculated based on the initial transmission time notified by a corresponding endpoint device. When image recognition for certain image data is completed, the thread deadline is extended by a transmission cycle notified by the endpoint device.

The number of waiting packets represents the number of remaining packets that the user thread is waiting for. The number of waiting packets decreases as some packets are received. Each poling start time is the time for starting a kernel thread for polling. If some packets are received before the polling start time, the polling start time is delayed. Counter values of the CPU 111 may be used for the thread deadline and the polling start time.

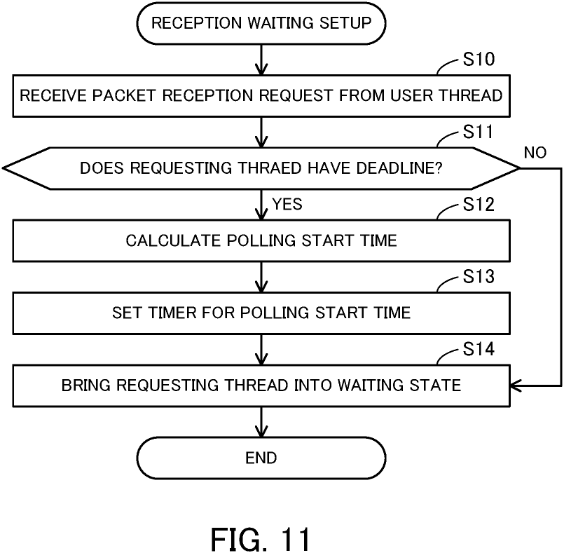

FIG. 11 is a flowchart illustrating an example of a procedure for reception waiting setup.

(Step S10) The OS 134 receives a packet reception request that includes an address of a memory area in user space and data length from a user thread.

(Step S11) The polling controlling unit 145 determines whether the user thread having made the packet reception request has a deadline assigned thereto. If it is a user thread with a deadline, the process moves to step S12. If it is a user thread with no deadline, the process moves to step S14.

(Step S12) The polling controlling unit 145 calculates the polling start time. At this time, the polling controlling unit 145 calculates the reception deadline D from the transmission time corresponding to the assigned deadline and the maximum delay time of the wireless communication network. The polling controlling unit 145 then calculates the polling start time from the average reception interval and the mix rate obtained from the reception history data, the number of waiting packets N, the thread start time α, and the reception deadline D.

(Step S13) The polling controlling unit 145 sets a timer that starts a kernel thread at the polling start time calculated in step S12.

(Step S14) The scheduler 146 brings the requesting user thread into a waiting state.

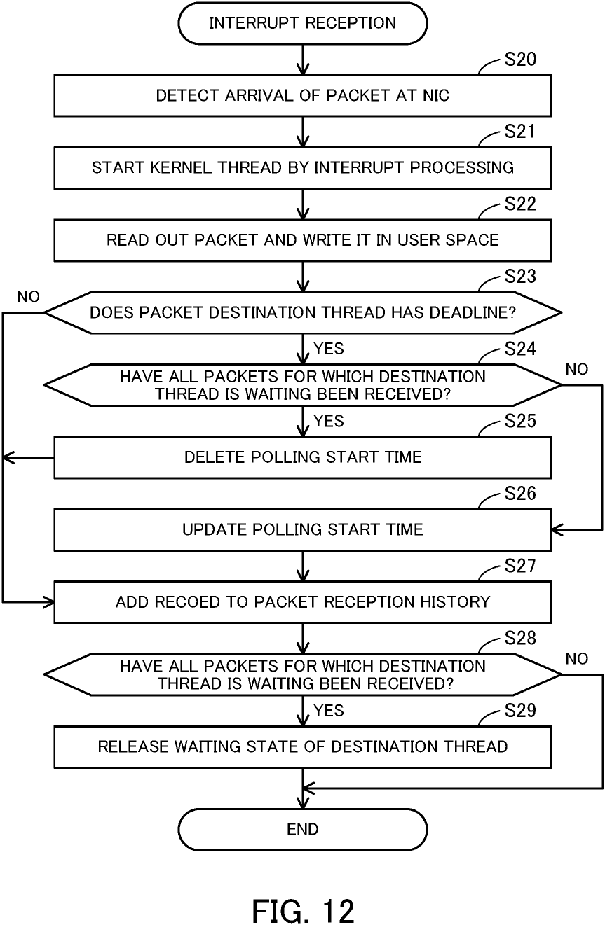

FIG. 12 is a flowchart illustrating an example of a procedure for interrupt reception.

(Step S20) The interrupting unit 143 detects that a packet has arrived at the NIC 117.

(Step S21) The interrupting unit 143 starts a kernel thread by interrupt processing. No deadline is given to the kernel thread.

(Step S22) The packet processing unit 141 reads out the packet from the receiving buffer and analyzes the header to determine a destination user thread. The packet processing unit 141 writes the packet to a memory area in user space, corresponding to the destination user thread.

(Step S23) The polling controlling unit 145 determines whether the destination of the packet is a user thread with a deadline. If it is a user thread with a deadline, the process moves to step S24. Otherwise, the process moves to step S27.

(Step S24) The polling controlling unit 145 determines whether all packets for which the destination user thread is waiting have been received. If reception of all the packets is completed, the process moves to step S25. If there is one or more unreceived packets, the process moves to step S26.

(Step S25) The polling controlling unit 145 deletes the polling start time. This stops the timer. Then, the process moves to step S27.

(Step S26) The polling controlling unit 145 updates the polling start time based on the number of remaining packets for the destination user thread.

(Step S27) The reception history managing unit 142 adds, to the packet reception history, a record indicating the reception time and the destination of the packet received this time.

(Step S28) The packet processing unit 141 determines whether all packets for which the destination user thread is waiting have been received. If reception of all the packets is completed, the process moves to step S29. If there is one or more unreceived packets, the interrupt reception ends.

(Step S29) The scheduler 146 releases the destination user thread from the waiting state. Note that, when two or more packets are stored in the receiving buffer, steps S22 to S29 are executed for each packet.

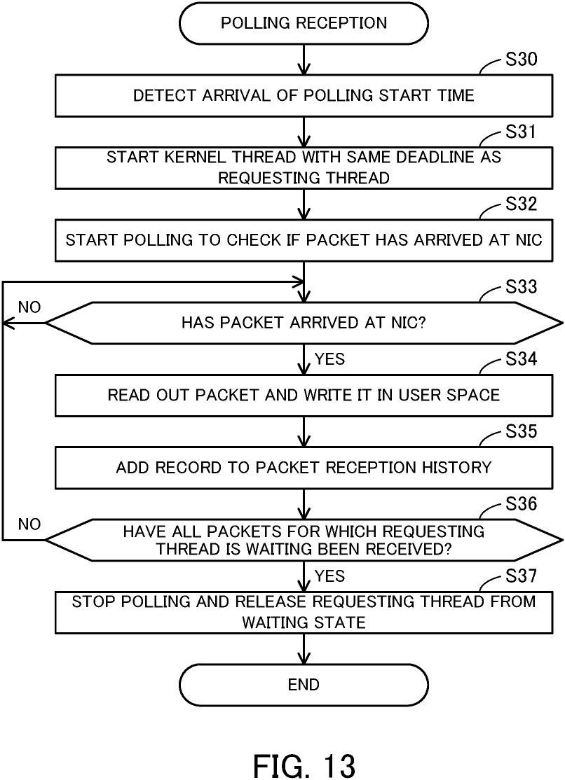

FIG. 13 is a flowchart illustrating an example of a procedure for polling reception.

(Step S30) The polling controlling unit 145 detects the arrival of the polling start time.

(Step S31) The polling controlling unit 145 starts a kernel thread if a kernel thread has not been started. The polling controlling unit 145 gives the kernel thread the same deadline as a user thread having made a packet reception request, and transfers control to the kernel thread.

(Step S32) The polling unit 144 starts polling to check whether a packet has arrived at the NIC 117. Polling is performed, for example, by repeatedly reading out a control flag that indicates the presence or absence of a packet from memory provided inside or outside the NIC 117.

(Step S33) The polling unit 144 determines whether a packet has arrived at the NIC 117. If a packet has arrived at the NIC 117, the process moves to step S34. If no packet has arrived at the NIC 117, step S33 is repeated again.

(Step S34) The packet processing unit 141 reads out the packet from the receiving buffer and analyzes the header to determine a destination user thread. The packet processing unit 141 writes the packet to a memory area of user space, corresponding to the destination user thread.

(Step S35) The reception history managing unit 142 adds, to the packet reception history, a record indicating the reception time and the destination of the packet received this time.

(Step S36) The packet processing unit 141 determines whether all packets for which the requesting user thread is waiting have been received. If reception of all the packets is completed, the process moves to step S37. If there is one or more unreceived packets, the process returns to step S33.

(Step S37) The polling unit 144 stops polling. The scheduler 146 releases the requesting user thread from the waiting state.

As described above, the edge server 34 of the second embodiment gives deadlines to user threads and performs deadline scheduling in which user threads with earlier deadlines are given higher priorities. This allows data processing to be completed within a specified period of time after an endpoint device generates data, thus increasing the value of the real-time application.

In addition, when network communication delay becomes significant, the edge server 34 starts a kernel thread to start polling before a packet arrives, and performs packet processing using the same kernel thread immediately after the packet arrives. As a result, the overhead after the arrival of the packet is reduced and the processing of the user thread starts earlier compared to when a kernel thread is started by interrupt processing after the arrival of the packet.

The polling kernel thread takes over the deadline of the user thread. Herewith, the kernel thread and other user threads with deadlines are scheduled with appropriate priorities, which reduces delay in packet processing of the kernel thread. As a result, delay in starting data processing of the user thread is reduced when network communication delay has become significant, which therefore ensures sufficient data processing time. In addition, the business operator running the edge server 34 is able to advance the deadline promised to the user of the endpoint device.

The edge server 34 determines the polling start time from the current data transmission time of the endpoint device and the maximum delay time of the wireless communication network. In addition, the edge server 34 adjusts the polling start time in consideration of the required start time of a kernel thread. Further, the edge server 34 calculates the average reception interval and the mix rate from the packet reception history, then estimates the required reception time of packets for which the user thread is waiting, and adjusts the polling start time in consideration of the required reception time. When some packets are received before the polling start time, the edge server 34 updates the polling start time. This is expected to start polling at an appropriate time just prior to packet arrival. As a result, polling is prevented from being needlessly long, which reduces the load on the edge server 34.

According to one aspect, it is possible to reduce delays in processing start of a user thread due to communication delay.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable recording medium storing therein a computer program that causes a computer to execute a process comprising:
determining, responsive to a user thread with a deadline waiting for a packet, a reference time that is associated with the deadline and comes before the deadline;
transferring, responsive to the packet being not received by a communication interface by the reference time, control to a kernel thread and causing the kernel thread to perform polling to repeatedly check reception status of the communication interface; and
causing, responsive to the packet being received by the communication interface during the polling, the kernel thread to read out the packet that has been received and pass the packet that has been read out to the user thread.

2. The non-transitory computer-readable recording medium according to claim 1, wherein the kernel thread is executed with priority given to the user thread according to the deadline.

3. The non-transitory computer-readable recording medium according to claim 1, wherein the reference time is determined using at least a start time that comes before the deadline and corresponds to the deadline and a maximum delay time of a network that transmits the packet.

4. The non-transitory computer-readable recording medium according to claim 1, wherein
the process further includes calculating, based on reception history data that indicates a reception time and a destination of each of a plurality of packets received by the communication interface in past, an average reception interval of the plurality of packets and a mix rate which is a ratio of packets not addressed to the user thread to the plurality of packets, and
the reference time is determined using the average reception interval and the mix rate.

5. The non-transitory computer-readable recording medium according to claim 1, wherein the process further includes updating, responsive to some of a plurality of packets being received before the reference time while the user thread is waiting for the plurality of packets, the reference time based on a number of remaining packets.

6. A packet receiving method comprising:
determining, by a processor, responsive to a user thread with a deadline waiting for a packet, a reference time that is associated with the deadline and comes before the deadline;
transferring, by the processor, responsive to the packet being not received by a communication interface by the reference time, control to a kernel thread and causing the kernel thread to perform polling to repeatedly check reception status of the communication interface; and
causing, by the processor, responsive to the packet being received by the communication interface during the polling, the kernel thread to read out the packet that has been received and pass the packet that has been read out to the user thread.

7. An information processing apparatus comprising:
a communication interface configured to receive a packet; and
a processor configured to execute a process including:
determining, responsive to a user thread with a deadline waiting for the packet, a reference time that is associated with the deadline and comes before the deadline,
transferring, responsive to the packet being not received by the communication interface by the reference time, control to a kernel thread and causing the kernel thread to perform polling to repeatedly check reception status of the communication interface, and
causing, responsive to the packet being received by the communication interface during the polling, the kernel thread to read out the packet that has been received and pass the packet that has been read out to the user thread.
